(19) United States
(12) Patent Application Publication
(10) Pub. No.: US 2023/0292646 A1
(43) Pub. Date: Sep. 21, 2023

(54) Rotary Driven Implement with Length Adjustable Drive Shaft

(71) Applicant: Dutch Blacksmith Shop Ltd., Pilot Butte (CA)

(72) Inventor: Sheldon Joseph Grywacheski, Humbolt (CA)

(21) Appl. No.: 18/183,360

(22) Filed: Mar. 14, 2023

(30) Foreign Application Priority Data
Mar. 15, 2022 (CA) 3152014

(51) Int. Cl. A01B 71/06; F16C 3/035; A01B 71/08

(52) U.S. Cl. CPC A01B 71/06; F16C 3/035; A01B 71/08

(57) ABSTRACT

An implement driven by a tractor having a drawbar and a power take-off defining a rotary output of the tractor, has a drive apparatus comprising (i) a driven assembly on the frame, (ii) a power take-off shaft connecting to the rotary output of the tractor, and (iii) an intermediate shaft assembly that is adjustable in length and which includes a forward end portion connected to the power take-off shaft and a rearward end portion driving the driven assembly of the implement. The forward and rearward end portions are telescopically connected to adjust the length thereof. A forward bearing assembly that rotatably supports the forward end portion of the intermediate shaft assembly on the frame can be mounted fixedly to the frame in a plurality of different positions spaced apart in the forward direction of the frame corresponding to different lengths of the intermediate shaft assembly.

This application claims foreign priority benefits from Canadian Patent Application 3,152,014 filed Mar. 15, 2022.

### FIELD OF THE INVENTION

The present invention relates to a drive apparatus for a rotary driven implement towed by a tractor to connect to the power take-off shaft of the implement to the power take-off of the tractor, and more particularly the present invention relates to a drive apparatus between the power take-off shaft and a driven assembly of the implement which is adjustable in length.

### BACKGROUND

Agricultural implements that are pulled by a tractor during operation and require power input from the tractor power take-off (PTO) output are subject to varying tractor draw bar to output shaft geometry. This varying tractor draw bar to PTO output geometry can result in an incorrect PTO shaft length between tractor and the implement that can cause a PTO shaft to be long or short. A PTO shaft that is too long for a particular tractor geometry can result in damage to the implement's drive line components or failure of the tractor PTO output components when turning. It is a common practice to supply a PTO shaft that is slightly longer than required and have the operator shorten PTO shaft for a particular tractor geometry. Shortening the PTO shaft may result in a shaft that is too short for another tractor geometry. Multiple PTO shafts of different lengths may be required when the implement is interchanged between tractors. PTO shafts are heavy and are costly.

Furthermore, at times it is desirable to interchange the tow hitch configuration of the implement that can also result in the implement hitch geometry either lengthening or shortening. This change in geometry results in a change in operating length of the PTO shaft. This change in operating geometry may again require shortening the drive shaft or a replacing the drive shaft with a longer working length which is costly and time consuming.

### SUMMARY OF THE INVENTION

According to one aspect of the invention there is provided a drive apparatus for an implement driven by a tractor having a drawbar and a power take-off defining a rotary output of the tractor, the implement comprising a frame including a hitch arm for connecting the frame to the drawbar of the tractor such that the implement can be towed in a forward working direction with the tractor, a driven assembly on the frame, and a power take-off shaft arranged for connection to the power-take-off of the tractor, the drive apparatus comprising:
an intermediate shaft assembly including a forward end portion and a rearward end portion telescopically connected to the forward end portion such that a length of the intermediate shaft assembly is adjustable;
the forward end portion of the intermediate shaft assembly being arranged for connection to the power take-off shaft of the implement;
the rearward end portion of the intermediate shaft assembly being arranged for connection to the driven apparatus of the implement;
a forward bearing assembly arranged for rotatably supporting the forward end portion of the intermediate shaft assembly rotatably on the frame of the implement;
a mounting arrangement supporting the forward bearing assembly in fixed relation to the frame in either one of a forward mounting location on the frame in a forward position of the forward bearing assembly or a rearward mounting location on the frame in a rearward position in which the rearward mounting location is spaced rearwardly of the forward mounting location;
the forward end portion of the intermediate shaft assembly being movable with the forward bearing assembly between the forward mounting location and the rearward mounting location so as to vary the length of the intermediate shaft assembly between the forward position to the rearward position of the forward bearing assembly.

According to a second aspect of the present invention there is provided an implement arranged to be towed by a tractor having a drawbar and a power take-off defining a rotary output of the tractor, the implement comprising:
a frame including a hitch arm for connecting the frame to the drawbar of the tractor such that the implement can be towed in a forward working direction with the tractor;
a driven assembly on the frame;
a power take-off shaft arranged for connection to the power-take-off of the tractor;
an intermediate shaft assembly including a forward end portion and a rearward end portion telescopically connected to the forward end portion such that a length of the intermediate shaft assembly is adjustable;
the forward end portion of the intermediate shaft assembly being connected to the power take-off shaft;
the rearward end portion of the intermediate shaft assembly being connected to the driven apparatus;
a forward bearing assembly rotatably supporting the forward end portion of the intermediate shaft assembly on the frame;
a mounting arrangement supporting the forward bearing assembly in fixed relation to the frame in either one of a forward mounting location on the frame in a forward position of the forward bearing assembly or a rearward mounting location on the frame in a rearward position in which the rearward mounting location is spaced rearwardly of the forward mounting location;
the forward end portion of the intermediate shaft assembly being movable with the forward bearing assembly between the forward mounting location and the rearward mounting location so as to vary the length of the intermediate shaft assembly between the forward position to the rearward position of the forward bearing assembly.

By allowing the front driveline bearing at the rear of the attached PTO shaft to move forward and rearward relative to the implement, it allows the operator to adjust the distance between the tractor PTO and the implement front drive line. This greatly reduce the requirement for cutting the drive shaft to match the tractor and implement geometry. Furthermore, by allowing the front portion of the implement drive line to be moved via bolts, the effective operating length of the PTO shaft can be changed to match various tractor and implement hitch configuration. This moveable front drive line bearing support may further cooperate with a driveline shield that is similarly telescoping to be adjustable in length according to the adjusted length of the intermediate driveline shaft.

The mounting arrangement is preferably arranged to support the forward bearing assembly in fixed relation to the frame in at least one intermediate mounting location on the frame between the forward mounting location and the rearward mounting location corresponding to a respective intermediate position of the mounting arrangement.

According to the illustrated embodiment, the mounting arrangement comprises a bracket assembly including an upper bracket supporting the forward bearing assembly therein and lower bracket mounted at a fixed location on the frame, in which the upper bracket is movable between the different mounting locations of the mounting arrangement with the forward bearing assembly, and the upper bracket is arranged to be fixedly mounted onto the lower bracket at each of the mounting locations of the mounting arrangement.

The mounting arrangement is preferably arranged to be fixedly mounted to the frame at each one of the mounting locations of the mounting arrangement using threaded fasteners. In this instance, the mounting arrangement preferably includes a row of fasteners apertures spaced apart in the forward working direction to define the mounting locations of the mounting arrangement respectively.

Preferably the rear end portion of the intermediate shaft assembly is rotatably supported on the frame at a fixed location in the forward working direction relative to the frame by a rearward bearing assembly.

The apparatus preferably includes a shield assembly including a front section extending overtop of the front end portion of the intermediate shaft assembly between the front bearing assembly and a junction between the front end portion and the rear end portion of the intermediate shaft assembly, in which the front section of the shield assembly is movable with the forward bearing assembly between the different mounting locations of the mounting arrangement.

When the shield assembly includes a front section and a rear section extending overtop of the intermediate shaft assembly between the front bearing assembly and a junction between the front end portion and the rear end portion of the intermediate shaft assembly, in which the front section and the rear section of the shield assembly are coupled to one another such that an overall length of the shield assembly is adjustable corresponding to adjustment of the length of the intermediate shaft assembly.

When the fasteners join the front section and the rear section of the shield assembly in overlapping arrangement with one another, the fasteners may be received in slots formed in at least one of the front section or the rear section in which the slots are elongate in the forward working direction to receive the fasteners slidably therein as the shield assembly is adjusted in overall length.

When the rear end portion of the intermediate shaft assembly is rotatably supported on the frame at a fixed location in the forward working direction relative to the frame by a rearward bearing assembly, the rear section of the shield assembly may be supported on the frame on a common mounting bracket with the rearward bearing assembly.

### BRIEF DESCRIPTION OF THE DRAWINGS

Some embodiments of the invention will now be described in conjunction with the accompanying drawings in which:

FIG. 1 is a side elevational view of the drive apparatus according to a first embodiment in which the apparatus is supported on a rotary driven implement shown connected in towing relationship with the drawbar of a tractor;

FIG. 2 is a perspective view from above of the drive apparatus according to the first embodiment of FIG. 1 on the hitch arm of the rotary driven implement;

FIG. 3 is a perspective view from below of the drive apparatus according to the first embodiment of FIG. 1 on the hitch arm of the rotary driven implement;

FIG. 4 is another perspective view of the drive apparatus according to the first embodiment of FIG. 1 shown on the hitch arm of the rotary driven implement with a front section of the shield assembly removed for illustrative purposes;

FIG. 5 is a sectional view of the drive apparatus according to the first embodiment of FIG. 1 along the line 5-5 in FIG. 2;

FIG. 6 is a perspective view of a connection between the front end of the intermediate shaft assembly and the power take-off shaft of the implement with a portion of the shield assembly removed for illustrative purposes according to the first embodiment of FIG. 1;

FIG. 7 is a sectional view of the drive apparatus along the line 7-7 in FIG. 2 in which the rear bearing assembly has been removed for illustrative purposes;

FIG. 8 is a side elevational view of the drive apparatus according to a second embodiment in which the apparatus is again shown supported on a rotary driven implement connected in towing relationship with the drawbar of a tractor; and

FIG. 9 is a perspective view from below of the drive apparatus according to the second embodiment of FIG. 8.

In the drawings like characters of reference indicate corresponding parts in the different figures.

### DETAILED DESCRIPTION

Referring to the accompanying figures, there is illustrated a rotary driven implement 10 having an adjustable drive apparatus 12. Although various embodiments are shown in the accompanying figures, the common features of the various embodiments will first be described.

The implement 10 is particularly suited for use with an agricultural tractor 14 for being towed across an agricultural field in a forward working direction together with the tractor. The tractor typically includes a drawbar 16 at the rear end thereof for connection to the implement so that the implement is towed by the tractor. In the illustrated example, the drawbar 16 comprises a clevis type connector receiving a hitch pin 18 therein for coupling the hitch connector 20 of the implement therein. The tractor further includes a power takeoff 22 defining a driven rotary output of the tractor for driving rotation of a driven assembly 24 of the implement.

The implement 10 generally includes a frame supported for movement across the ground in the forward working direction of the tractor. The frame includes a hitch arm 26 protruding forwardly from a main working portion of the frame to support the hitch connector 20 at the forward end thereof. In the illustrated embodiment, the hitch connector 20 comprises a tongue having pin aperture therein for cooperation with the hitch pin 18 of the towing connection between the tractor and the implement.

The frame of the implement supports the driven assembly 24 thereon. The driven assembly 24 may take various forms, for example a rotating mower blade when the implement is a mower, or a rotating earthmoving blade when the implement is a rotary ditch forming implement. More particularly, the portion of the driven assembly 24 that is directly coupled to the adjustable drive apparatus 12 may comprise an intermediate drive component including a gear box, a belt drive, a drive shaft extension, a chain drive, a hydraulic drive, or other suitable drive component.

In each instance, the implement includes a power takeoff (PTO) shaft 28 arranged for connection to the rotary output 22 of the tractor for transmitting rotary drive from the tractor to an intermediate shaft assembly 30 which in turn is connected to the driven assembly for driving rotation of the driven assembly. The PTO shaft is located at the forward end of the implement. The PTO shaft 28 includes a first universal joint 32 at the front end thereof in connection with the rotary output 22 of the tractor, a second universal joint 34 at the rear end thereof in connection with the intermediate shaft assembly 30 of the implement and a telescoping drive shaft 36 connected between the first and second universal joints 32 and 34 such that the overall length of the telescopic drive shaft 36 is adjustable within a prescribed range.

In a typical tractor configuration, the first end of the PTO shaft 28 is connected to the rotary output 22 of the tractor at a location spaced above and spaced forwardly of the pin connection of the drawbar 16 of the tractor. The relative position of the rotary output 22 and the pin connection of the drawbar 16 define the turning geometry of the implement relative to the tractor.

The adjustable drive apparatus 12 according to the present invention relates to the intermediate shaft assembly 30 for connection between the PTO shaft 28 and the driven assembly 24 of the implement. The intermediate shaft assembly 30 generally includes a forward end portion 38 defining a front end of the intermediate shaft assembly in connection with the rear end 34 of the PTO shaft 28 and a rearward end portion 40 defining a rear end of the intermediate shaft assembly in connection with a gearbox forming part of the driven assembly 24 of the implement.

The rearward end portion is fixed in a longitudinal direction relative to the frame of the implement and is rotatably supported towards the rear end thereof by a rearward bearing assembly 42. The forward end portion is rotatably supported on the frame by a forward bearing assembly 44 in proximity to the forward end of the intermediate shaft assembly.

The drive apparatus 12 of the present invention further includes a mounting arrangement supporting the forward bearing assembly 44 in fixed relation to the frame in either one of a plurality of mounting locations on the frame longitudinally spaced apart from one another in the forward working direction of the implement corresponding to different operating positions of the drive apparatus. The mounting locations include a forward mounting location on the frame in a forward position of the forward bearing assembly, a rearward mounting location on the frame in a rearward position in which the rearward mounting location is spaced rearwardly of the forward mounting location, and a plurality of intermediate mounting locations at evenly spaced apart positions between the forward mounting location and the rearward mounting location corresponding to respective intermediate positions of the forward bearing assembly relative to the frame.

The forward end portion 38 of the intermediate shaft assembly 30 is a male splined shaft arranged to be telescopically received within a forward end of the rearward end portion 40 which defines a female splined shaft that is tubular in shape with internal grooves that mate with corresponding splines on the exterior of the forward end portion 38. In this manner the forward end portion and the rearward end portion of the intermediate shaft assembly 30 are telescopically connected to be adjustable in overall length by relative sliding in the axial direction relative to one another while remaining coupled to rotate together for transmitting drive through the intermediate shaft assembly. The forward end portion 38 further includes a connecting stub 46 at the forward end thereof which is rotatably supported within the forward bearing assembly and which is connected at the forward end forwardly of the forward bearing assembly to the rear end 34 of the PTO shaft 28. Similarly, the rearward end portion 40 of the intermediate shaft assembly includes a rear connecting stub 48 at the rear end for connection to the intermediate drive component of the driven assembly 24 of the implement.

The mounting arrangement of the forward bearing assembly 44 according to the illustrated embodiment is a forward bracket assembly including two lower brackets 50 mounted fixedly and immovably along laterally opposing sides of the hitch arm of the frame, and an upper bracket 52 connected between the lower brackets 50 across the top side of the hitch arm. Each lower bracket 50 comprises a rigid frame member including a bottom flange 54 which is vertically oriented and mounted to extend longitudinally alongside the hitch arm and a side flange 56 extending perpendicularly and laterally outward from the top edge of the bottom flange 54 so as to be flush with the top side of the hitch arm. Each of the side flanges includes a row of fastener apertures 58 therein in which each fastener aperture of one lower bracket 50 aligns with a corresponding fastener aperture in the other bracket such that the aligned pair of fastener apertures collectively defines one of the mounting positions of the forward bearing assembly relative to the frame respectively.

The upper bracket 52 comprises an upright plate 60 spanning across a width of the hitch arm between the two lower brackets 50 and a bottom flange 62 fixed to the bottom edge of the upright plate 60 to be perpendicular to the upright plate and lie horizontally across the top side of the hitch arm and the side flanges 56 of the two lower brackets 50. Fastener apertures at opposing ends of the bottom flange 62 receive respective fasteners 64 which selectively couple the bottom flange to a corresponding pair of fastener apertures 58 of the lower brackets 50 corresponding to a designated mounting position of the forward bearing assembly relative to the frame.

A bearing aperture 66 is centrally located within the upright plate 60 mounted the forward bearing assembly 44 therein. The forward bearing assembly 44 is a rotary bearing which receives the forward end portion of the intermediate shaft assembly extending therethrough to support the forward end of the shaft rotatably relative to the frame of the implement while also acting to locate the forward end portion of the shaft longitudinally in the forward working direction of the implement relative to the frame of the implement. The forward bearing assembly 44 rotatably couples the forward end portion of the intermediate shaft assembly to the upper bracket 52 so that the forward end portion of the shaft assembly, the upper bracket 52 and the forward bearing assembly 44 are collectively movable together in the longitudinal direction of the shaft between the forward, intermediate and rearward mounting locations of the forward bearing assembly.

At a location spaced rearwardly of the forward bearing assembly, a rear bracket 68 receives the rearward bearing assembly 42 therein for rotatably supporting the rear end portion 40 of the intermediate shaft assembly relative to the frame of the implement. The rear bracket 68 is an upright plate which is mounted onto the top side of the hitch arm of the frame at a single fixed location, immovable relative to the frame. The rear bracket 68 includes a bearing aperture 70 therein which receives the rear bearing assembly 42 to rotatably support the rear end portion 40 of the shaft extending through the bearing for connection to the gearbox of the driven assembly at a location spaced rearwardly of the rear bracket 68. The rear bearing assembly supports the rearward end portion 40 of the intermediate shaft assembly such that the rearward end portion 40 is fixed in a longitudinal direction of the frame relative to the frame and the driven assembly on the frame.

The drive apparatus 12 according to the present invention further includes a shield assembly including a rear section 72 extending forwardly from the rear bracket 68 to extend over top of at least part of the rearward end portion 40 of the intermediate shaft assembly, and a forward section 74 extending between the rear section 72 and the forward bracket assembly of the mounting arrangement.

Each of the forward section and the rear section of the shield assembly includes a top plate 76 having a width which is approximately equal to the width of the hitch arm below while being supported to extend horizontally at a location spaced above the intermediate shaft assembly such that the intermediate shaft assembly is centrally located between the hitch arm below and the top plate 76 of the shield assembly above. Each of the forward and rearward sections of the shield assembly further includes a pair of side plates 78 which extend downward and laterally outward at a slope from opposing longitudinally extending side edges of the top plates 76 respectively. The side plates have bottom edges located at an elevation similar to the elevation of the top of the hitch arm such that laterally opposing sides of the intermediate shaft assembly are substantially concealed and covered by the side plates 78 of the shield assembly.

The rear section 72 of the shield assembly is supported at its rear edge at a location spaced above the hitch arm so as to be fixed and immovable relative to the hitch arm.

The forward section 74 of the shield assembly is coupled at the forward edge of the top plate 76 to the top edge of the upright plate 60 of the upper bracket 52 of the forward bracket assembly. The top plate 76 of the forward section 74 extends horizontally rearward so that a rear portion of the forward section 74 overlaps a forward portion of the rear section 72 at an intermediate location between the forward and rearward brackets of the intermediate shaft assembly. By coupling the forward section of the shield assembly to the upper bracket 52 that supports the forward bearing assembly 44, the forward section 74 of the shield assembly is also movable together with the forward bearing assembly 44 between the different mounting locations thereof for adjusting the overall length of the shield assembly defined between the rear end of the rear section and the front end of the forward section together with the length adjustment of the intermediate shaft assembly.

The forward and rearward sections of the shield assembly are coupled by a pair of fasteners 80 which are mounted within respective mounting apertures in the rear section 72 of the shield assembly at laterally spaced apart positions for communication with respective fastener apertures formed in the overlapping forward section 74 of the shield assembly. Either one or both of the mounting apertures in the rear section 72 or the fastener apertures in the front section 74 are formed as slots 82 which are elongated in the forward working direction corresponding to the direction of longitudinal sliding movement between the sections of the shield assembly such that the fasteners 80 are displaced longitudinally along the slots as the forward and rearward sections are longitudinally displaced relative to one another. Once a desired mounting position of the forward bearing assembly has been selected, the fasteners 80 can be tightened to assist in fixing the forward and rearward sections of the shield assembly immovably relative to one another.

The shield assembly further includes an auxiliary shield 84 mounted on the forward bracket assembly to extend forwardly therefrom. The auxiliary shield 84 includes a top plate 86 hinged at a rear edge thereof on the top edge of the upper bracket 52 of the forward bracket assembly to extend horizontally forward therefrom above the connection between the front end of the intermediate shaft assembly and the rear end 34 of the PTO shaft 28. The auxiliary shield 84 further includes two side plates 88 that extend downwardly from opposing side edges of the top plate while being spaced apart laterally to receive the rear end of the PTO shaft 28 therebetween. The side plates are arranged so that the rear edges of the side plates are vertical when the top plate 86 is horizontal, while being spaced laterally apart such that the rear edges abut the front face of the upper bracket 52 at laterally opposing sides of the forward bearing assembly 44. The engagement of the side plates with the upper bracket 52 prevent downward pivoting of the top plate 86 to support the top plate 86 horizontally in a normal working position. The hinged connection however allows the auxiliary shield 84 to be pivoted upwardly from the normal working position for access to the connection between the PTO shaft 28 and the forward end of the intermediate shaft assembly.

The drive apparatus 12 according to the present invention is typically installed in place of a fixed length driveshaft that normally connects between the PTO shaft 28 and the driven assembly 24 of a rotary driven implement. The rear bracket 68, the rear bearing assembly 42 supported by the rear bracket, and the rear end portion 40 of the driveshaft assembly 30 all remain fixed and immovable in the longitudinal direction of the shaft relative to the frame, while the rear end portion remains rotatable.

Conventionally, when adjusting the implement to be suited with a particular tractor configuration, it is occasionally required to shorten or length the PTO shaft 28 so that the telescoping operating range of the PTO shaft 28 corresponds to the turning geometry of the tractor. When using the intermediate shaft assembly 30 according to the present invention however, rather than adjusting the length of the PTO shaft 28 by cutting the shaft shorter or replacing the shaft with a longer shaft, the mounting location of the rear end of the PTO shaft 28 can instead be adjusted relative to the frame of the implement by lengthening or shortening the intermediate shaft assembly 30 by repositioning of the forward bracket assembly supporting the forward bearing assembly 44 therein which in turn supports the forward end portion 38 of the intermediate shaft assembly rotatably on the frame. In this manner, the PTO shaft 28 can be operated within its prescribed telescoping range between the intermediate shaft assembly and the rotary output of the tractor as the implement follows the tractor through various turns, regardless of the geometry between the tractor and implement connections, without cutting or replacing the PTO shaft 28 to vary its operating range.

If the implement is desired to be used with a different tractor having a longer PTO shaft 28 requirement, then the bracket assembly supporting the forward bearing assembly 44 can simply be moved forwardly to a different mounting location to provide the same effective function as lengthening of the PTO shaft 28.

Alternatively, if the implement is desired to be used with a different tractor having a shorter PTO shaft 28 requirement, then the bracket assembly supporting the forward bearing assembly 44 can simply be moved rearwardly to a different mounting location to provide the same effective function as shortening of the PTO shaft 28.

Once the mounting location of the forward bearing assembly 44 has been selected, the forward bracket assembly is secured with threaded fasteners so as to be immovable relative to the frame of the implement. In this manner, the forward bearing assembly and the front end portion 38 of the intermediate shaft assembly remain fixed and immovable in longitudinal position relative to the hitch arm and the frame of the implement throughout operation of the implement relative to the tractor. The telescoping arrangement of the PTO shaft 28 will accommodate any difference in length required as a result of the tractor towing geometry while navigating through turns without any further length adjustment of the intermediate shaft assembly 30 being required.

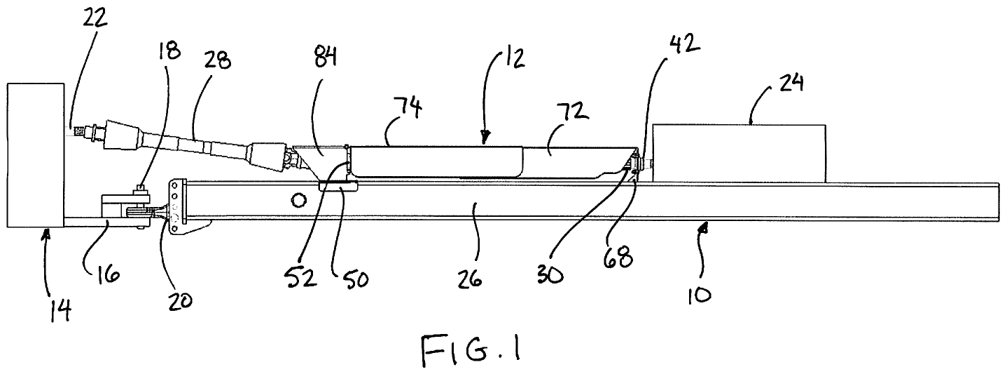

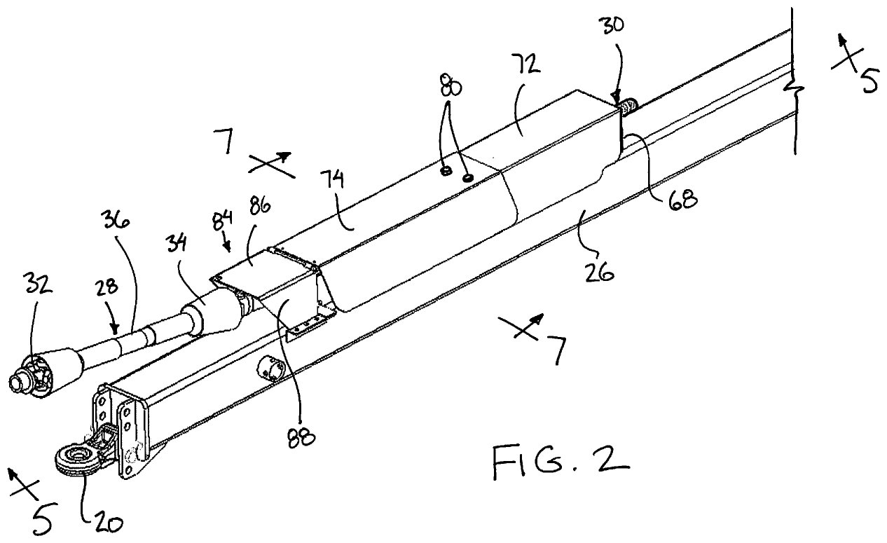

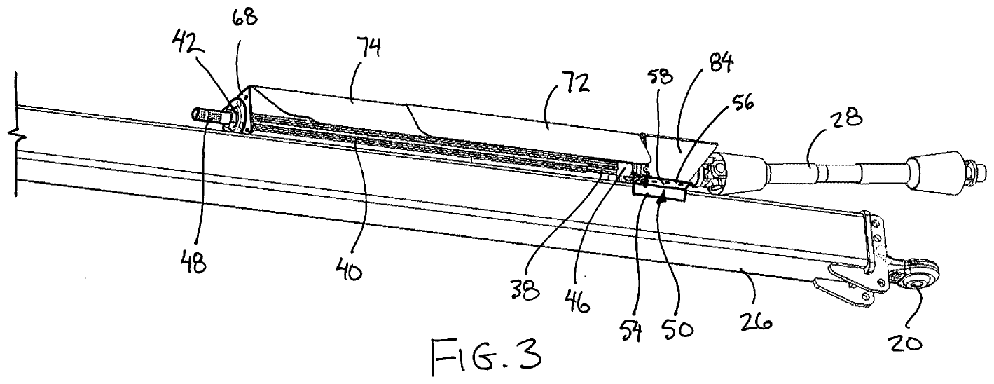

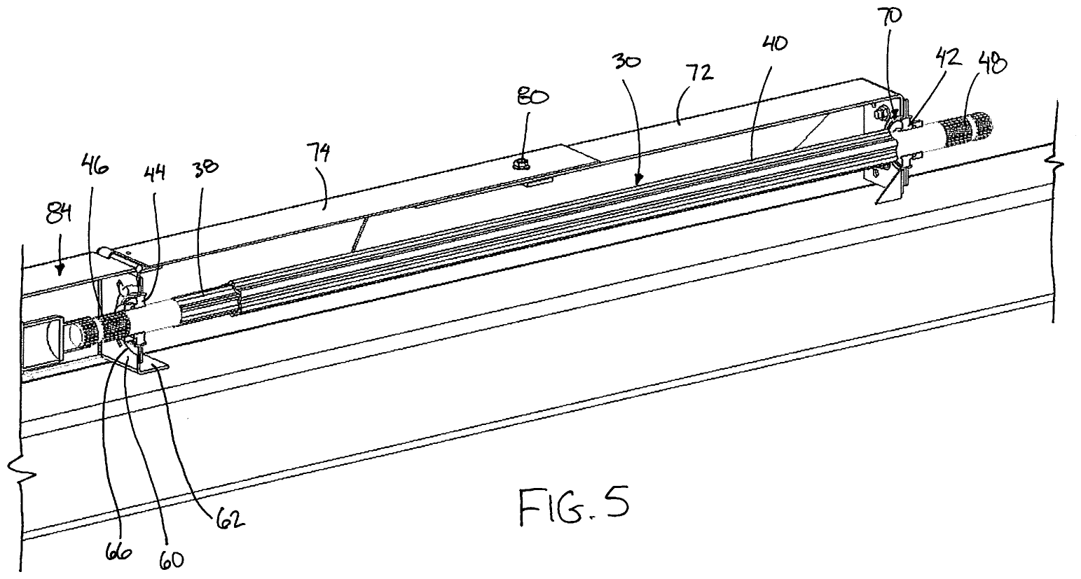

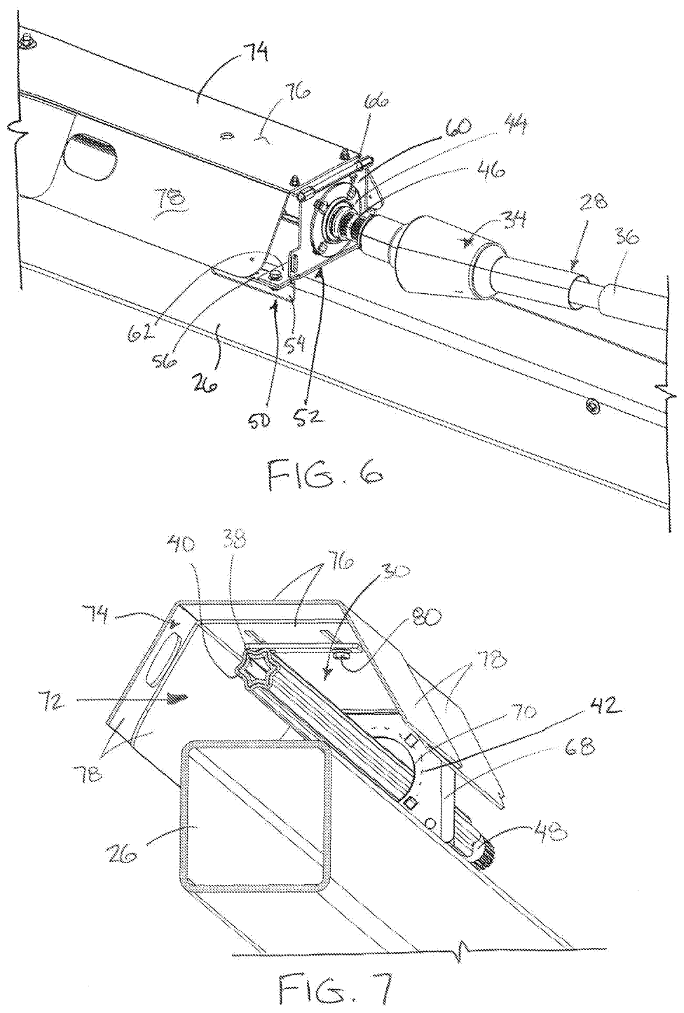

Turning now to the first embodiment of FIGS. 1 through 7, in this instance, the rear bracket 68 that supports the rear bearing assembly 42 is situated at the rear end of the rear section 72 of the shield. Accordingly, in this instance the rear edge of the rear section 72 of the shield can be integrally fixed with the top edge of the rear bracket 68 so that the rear bracket supports the rear section 72 of the shield relative to the hitch arm 26. The connecting stub 48 at the rearward end portion 40 of the intermediate drive shaft 30 in this instance may be located immediately rearward of the shield for connection to an intermediate drive component of the driven assembly 24 of the implement.

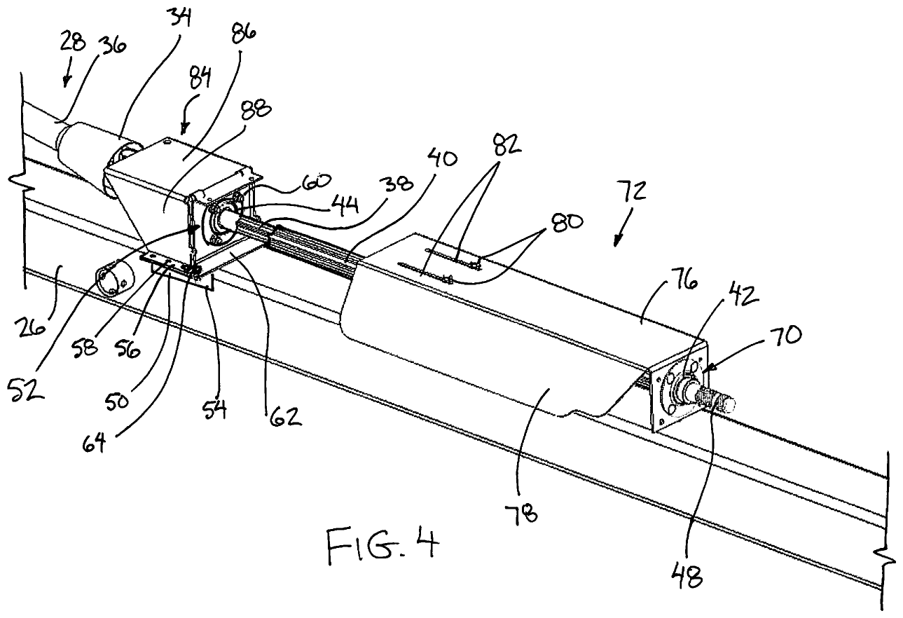

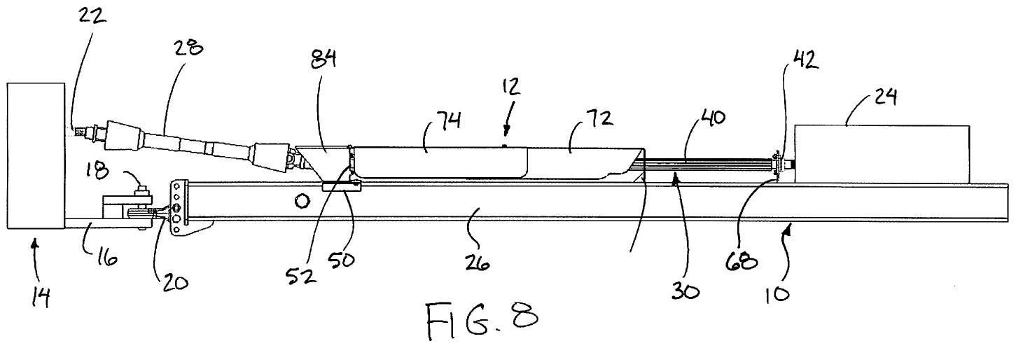

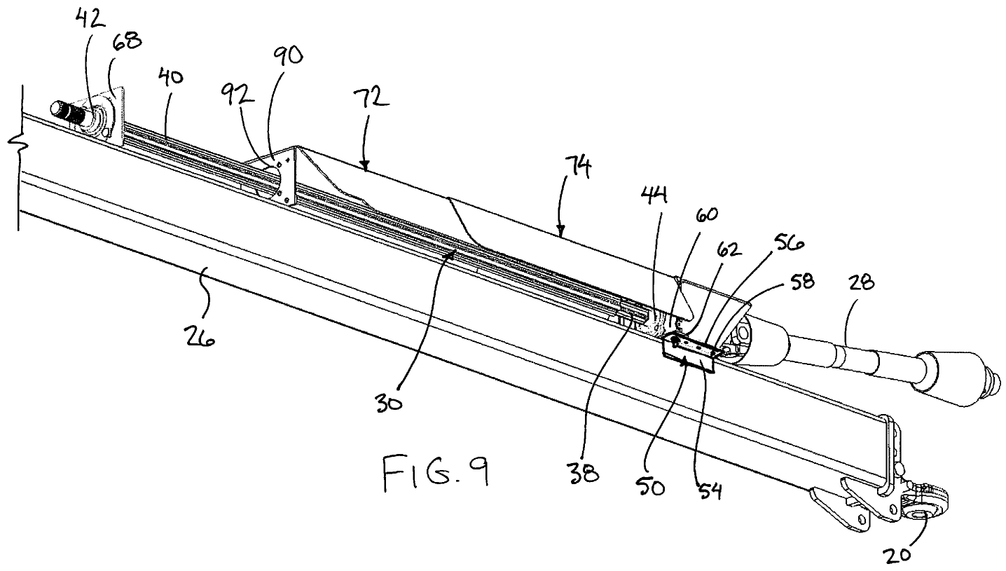

Turning now to the second embodiment of FIGS. 8 and 9, in this instance, the rear bracket 68 that supports the rear bearing assembly 42 therein is situated at a location spaced rearwardly of the rear section 72 of the shield so as to provide rotatable support at the rear end portion of a much longer intermediate drive shaft 30 than the previous embodiment. The rear section 72 of the shield is again supported at its rear edge relative to the hitch arm 26 but support is instead provided by an intermediate bracket 90 separate from the rear bracket 68 that supports the rear bearing assembly 42 therein. The intermediate bracket 90 comprises an upright plate having a central aperture 92 therein through which the intermediate driveshaft can extend. The upright plate of the intermediate bracket 90 has a top edge which is integrally fixed with the rear edge of the rear section 72 of the shield such that the intermediate bracket 90 of the second embodiment according to FIG. 9 is substantially identical to the rear bracket 68 of the first embodiment as shown in FIG. 4. Furthermore, the central aperture 92 of the intermediate bracket 90 in the second embodiment of FIG. 9 is substantially identical to the aperture 70 of the rear plate 68 of the first embodiment as shown in FIG. 7.

Accordingly, regardless of the intended use of the adjustable drive apparatus 12 according to either the first embodiment or the second embodiment, in either instance the rear section 72 of the shield can be manufactured with an integral upright plate joined to the rear edge of the top plate 76 of the rear section 72 which is then mounted in fixed relation to the hitch arm 26.

In the instance of the first embodiment, the rear bearing assembly 42 is mounted into the aperture of the upright plate at the rear of the rear section 72 of the shield such that the upright plate of the rear section 72 of the shield defines the rear bracket 68 shown in FIGS. 1 to 7.

Alternatively in the instance of the second embodiment, the upright plate at the rear of the rear section 72 of the shield remains free of any rear bearing to define the intermediate bracket 90 with the shaft passing through the aperture 92 that has no bearing therein, while the rear bearing assembly 42 is instead mounted within the separate upright plate spaced rearwardly from the shield to function as the rear bracket assembly 68 according to FIGS. 8 and 9.

Since various modifications can be made in the invention as herein above described, and many apparently widely different embodiments of same made, it is intended that all matter contained in the accompanying specification shall be interpreted as illustrative only and not in a limiting sense.

1. A drive apparatus for an implement driven by a tractor having a drawbar and a power take-off defining a rotary output of the tractor, the implement comprising a frame including a hitch arm for connecting the frame to the drawbar of the tractor such that the implement can be towed in a forward working direction with the tractor, a driven assembly on the frame, and a power take-off shaft arranged for connection to the power-take-off of the tractor, the drive apparatus comprising:
an intermediate shaft assembly including a forward end portion and a rearward end portion telescopically connected to the forward end portion such that a length of the intermediate shaft assembly is adjustable;
the forward end portion of the intermediate shaft assembly being arranged for connection to the power take-off shaft of the implement;
the rearward end portion of the intermediate shaft assembly being arranged for connection to the driven apparatus of the implement;
a forward bearing assembly arranged for rotatably supporting the forward end portion of the intermediate shaft assembly rotatably on the frame of the implement;
a mounting arrangement supporting the forward bearing assembly in fixed relation to the frame in either one of a forward mounting location on the frame in a forward position of the forward bearing assembly or a rearward mounting location on the frame in a rearward position in which the rearward mounting location is spaced rearwardly of the forward mounting location;
the forward end portion of the intermediate shaft assembly being movable with the forward bearing assembly between the forward mounting location and the rearward mounting location so as to vary the length of the intermediate shaft assembly between the forward position to the rearward position of the forward bearing assembly.

2. The apparatus according to claim 1 wherein the mounting arrangement is arranged to support the forward bearing assembly in fixed relation to the frame in at least one intermediate mounting location on the frame between the forward mounting location and the rearward mounting location corresponding to a respective intermediate position of the mounting arrangement.

3. The apparatus according to claim 1 wherein the mounting arrangement comprises a bracket assembly including an upper bracket supporting the forward bearing assembly therein and lower bracket mounted at a fixed location on the frame, the upper bracket being movable between the different mounting locations of the mounting arrangement with the forward bearing assembly, and the upper bracket being arranged to be fixedly mounted onto the lower bracket at each of the mounting locations of the mounting arrangement.

4. The apparatus according to claim 1 wherein the mounting arrangement is arranged to be fixedly mounted to the frame at each one of the mounting locations of the mounting arrangement using threaded fasteners.

5. The apparatus according to claim 1 the mounting arrangement includes a row of fasteners apertures spaced apart in the forward working direction to define the mounting locations of the mounting arrangement respectively.

6. The apparatus according to claim 1 wherein the rear end portion of the intermediate shaft assembly is rotatably supported on the frame by a rearward bearing assembly at a fixed location in the forward working direction relative to the frame.

7. The apparatus according to claim 1 further comprising a shield assembly including a front section extending overtop of the front end portion of the intermediate shaft assembly between the front bearing assembly and a junction between the front end portion and the rear end portion of the intermediate shaft assembly, the front section of the shield assembly being movable with the forward bearing assembly between the different mounting locations of the mounting arrangement.

8. The apparatus according to claim 1 further comprising a shield assembly including a front section and a rear section extending overtop of the intermediate shaft assembly between the front bearing assembly and a junction between the front end portion and the rear end portion of the intermediate shaft assembly, the front section and the rear section of the shield assembly being coupled to one another such that an overall length of the shield assembly is adjustable corresponding to adjustment of the length of the intermediate shaft assembly.

9. The apparatus according to claim 8 including fasteners joining the front section and the rear section of the shield assembly in overlapping arrangement with one another, the fasteners being received in slots formed in at least one of the front section or the rear section in which the slots are elongate in the forward working direction to receive the fasteners slidably therein as the shield assembly is adjusted in overall length.

10. The apparatus according to claim 8 wherein the rear end portion of the intermediate shaft assembly is rotatably supported on the frame at a fixed location in the forward working direction relative to the frame by a rearward bearing assembly and wherein the rear section of the shield assembly is supported on the frame on a common mounting bracket with the rearward bearing assembly.

11. An implement arranged to be towed by a tractor having a drawbar and a power take-off defining a rotary output of the tractor, the implement comprising:
a frame including a hitch arm for connecting the frame to the drawbar of the tractor such that the implement can be towed in a forward working direction with the tractor;
a driven assembly on the frame;
a power take-off shaft arranged for connection to the power-take-off of the tractor;
an intermediate shaft assembly including a forward end portion and a rearward end portion telescopically connected to the forward end portion such that a length of the intermediate shaft assembly is adjustable;
the forward end portion of the intermediate shaft assembly being connected to the power take-off shaft;
the rearward end portion of the intermediate shaft assembly being connected to the driven apparatus;
a forward bearing assembly rotatably supporting the forward end portion of the intermediate shaft assembly on the frame;
a mounting arrangement supporting the forward bearing assembly in fixed relation to the frame in either one of a forward mounting location on the frame in a forward position of the forward bearing assembly or a rearward mounting location on the frame in a rearward position in which the rearward mounting location is spaced rearwardly of the forward mounting location;
the forward end portion of the intermediate shaft assembly being movable with the forward bearing assembly between the forward mounting location and the rearward mounting location so as to vary the length of the intermediate shaft assembly between the forward position to the rearward position of the forward bearing assembly.

12. The implement according to claim 11 wherein the mounting arrangement is arranged to support the forward bearing assembly in fixed relation to the frame in at least one intermediate mounting location on the frame between the forward mounting location and the rearward mounting location corresponding to a respective intermediate position of the mounting arrangement.

13. The implement according to claim 11 wherein the mounting arrangement comprises a bracket assembly including an upper bracket supporting the forward bearing assembly therein and lower bracket mounted at a fixed location on the frame, the upper bracket being movable between the different mounting locations of the mounting arrangement with the forward bearing assembly, and the upper bracket being arranged to be fixedly mounted onto the lower bracket at each of the mounting locations of the mounting arrangement.

14. The implement according to claim 11 wherein the mounting arrangement is arranged to be fixedly mounted to the frame at each one of the mounting locations of the mounting arrangement using threaded fasteners.

15. The implement according to claim 11 the mounting arrangement includes a row of fasteners apertures spaced apart in the forward working direction to define the mounting locations of the mounting arrangement respectively.

16. The implement according to claim 11 wherein the rear end portion of the intermediate shaft assembly is rotatably supported on the frame at a fixed location in the forward working direction relative to the frame by a rearward bearing assembly.

17. The implement according to claim 11 further comprising a shield assembly including a front section extending overtop of the front end portion of the intermediate shaft assembly between the front bearing assembly and a junction between the front end portion and the rear end portion of the intermediate shaft assembly, the front section of the shield assembly being movable with the forward bearing assembly between the different mounting locations of the mounting arrangement.

18. The implement according to claim 11 further comprising a shield assembly including a front section and a rear section extending overtop of the intermediate shaft assembly between the front bearing assembly and a junction between the front end portion and the rear end portion of the intermediate shaft assembly, the front section and the rear section of the shield assembly being coupled to one another such that an overall length of the shield assembly is adjustable corresponding to adjustment of the length of the intermediate shaft assembly.

19. The implement according to claim 18 including fasteners joining the front section and the rear section of the shield assembly in overlapping arrangement with one another, the fasteners being received in slots formed in at least one of the front section or the rear section in which the slots are elongate in the forward working direction to receive the fasteners slidably therein as the shield assembly is adjusted in overall length.

20. The implement according to claim 18 wherein the rear end portion of the intermediate shaft assembly is rotatably supported on the frame at a fixed location in the forward working direction relative to the frame by a rearward bearing assembly and wherein the rear section of the shield assembly is supported on the frame on a common mounting bracket with the rearward bearing assembly.
